(19) United States
(12) Patent Application Publication
(10) Pub. No.: US 2007/0109468 A1
(43) Pub. Date: May 17, 2007

(54) Systems with reduced color lines at edges of associated display devices

(75) Inventor: Norio Oku, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/274,022

(22) Filed: Nov. 15, 2005

(51) Int. Cl. G02F 1/1333

(52) U.S. Cl. 349/110

(57) ABSTRACT

Systems for reducing color lines at edges of a display are provided. An exemplary system comprises a display that includes a peripheral region and a non-peripheral region. A plurality of sub-pixels arranged in the peripheral region exhibit brightness lower than that of the sub-pixels disposed in the non-peripheral region.

### BACKGROUND OF THE INVENTION

1. Field of the Invention

The present invention relates to display devices.

2. Description of the Related Art

Flat panel display devices, such as liquid crystal displays (LCDs), electroluminescent (EL) displays and plasma display panels (PDPs), have been rather popular and have widely replaced conventional cathode ray tube (CRT) display devices. Flat panel display devices have been adapted with electronic apparatuses, such as television sets, computer systems, mobile phones, game players and the like. The mechanism to display an image for such a flat panel display device is the dot mechanism. Thus, the image displayed by a flat panel display device is composed of an array of color dots. One color dot is also called a pixel, which usually includes three sub-pixels with each sub-pixel being characterized by a different one of the three primary colors of red (R), green (G), and blue (B). Since any color can be formed from these three primary color sub-pixels, a desired color at the corresponding pixel can be obtained by controlling the illumination intensity of the sub-pixels. If the intensities of the three primary color sub-pixels are equal, a white color (W) can appear after light mixing.

FIG. 1 is a schematic view showing a conventional display panel. As shown in FIG. 1, the display panel has a display area 110 and a non-display area 112. A plurality of pixels are formed in the display area 110, and each pixel includes three sub-pixels with respect to three primary colors, R, G and B. For example, pixel 100 includes sub-pixels 101R, 101G and 101B. For a stripe-type display panel, each of the R, G and B sub-pixels is arranged in a column with other sub-pixels of like color, thus forming colored stripes. In this manner, the display area 110 usually includes a middle region 106 and side regions 102 and 104. Therefore, only one of the primary colors is disposed in each of the side regions 102 and 104. Here, the colors for the side regions 102, 104 are red and blue. Notably, in such a configuration the middle region 106 can display a white color because of a color mixing effect. However, the side regions 102 and 104 exhibit a poor color mixing effect, and therefore the red and blue color lines can be noticeable at the two edges of the display panel.

In order to reduce the foregoing phenomenon of the color lines being noticeable at the two edges of the display panel, another sub-pixel arrangement has been proposed as shown in FIG. 2. In FIG. 2, pixel 200 at the first row has the same sub-pixel sequence (RGB) as that of pixel 100 in FIG. 1. However, pixel 220 at the second row has another sub-pixel sequence (BGR). In this conventional design, the side region 122 exhibits an alternating sub-pixel sequence of R, B and side region 124 exhibits an alternating sub-pixel sequence of B, R to increase the color mixing effect. However, this design in FIG. 2 still cannot completely eliminate the color lines at the edges of the display panel.

### SUMMARY OF THE INVENTION

Systems for reducing color lines at edges of a display are provided. An exemplary embodiment of such a system comprises a display comprising a peripheral region and a non-peripheral region, with the non-peripheral region including at least a central image-displaying portion of the display, and the peripheral region including at least one image-displaying edge portion of the display. The peripheral region and the non-peripheral region comprise sub-pixels, wherein the sub-pixels disposed in the peripheral region have a brightness lower than that of the sub-pixels disposed in the non-peripheral region.

Another embodiment of a system for reducing color lines at edges of a display comprises a display. The display comprises pixels having sub-pixels arranged in a striped configuration such that sub-pixels of a first color are located in an outermost column of the sub-pixels. A brightness of the sub-pixels of the outermost column is lower than a brightness of other sub-pixels located closer to a center of a display portion of the display.

It is to be understood that both the foregoing general description and the following detailed description are exemplary and explanatory only and are not restrictive of the invention, as claimed.

### BRIEF DESCRIPTION OF THE DRAWINGS

FIG. 1 and FIG. 2 are schematic top views showing two conventional display panels.

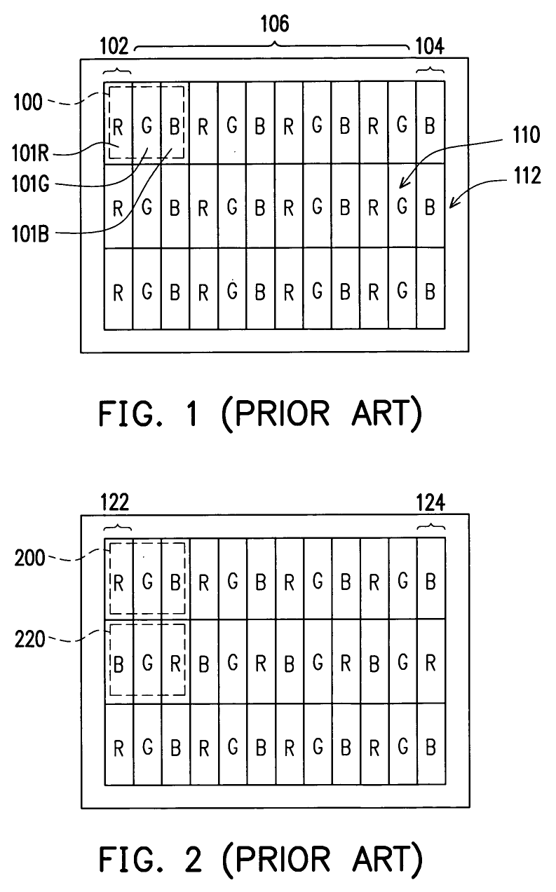

FIG. 3 is a schematic top view showing a display panel according to an embodiment of the present invention.

FIGS. 4-9 are schematic top views each showing one pixel near the edge of a corresponding display panel according to several embodiments of the present invention.

FIG. 10 is a schematic view of a system incorporating an embodiment of a display device.

FIG. 11 is a schematic view of another system incorporating another embodiment of a display device.

### DETAILED DESCRIPTION

Systems with reduced color lines at edges of associated displays are provided. In some embodiments, such a system incorporates a display device that includes pixels and corresponding sub-pixels. The sub-pixels exhibit reduced effective brightness in the peripheral region of the display. Potentially, this configuration can effectively improve the color balance at edges of the display device and thereby improve the displaying quality. Several examples or embodiments will now be described.

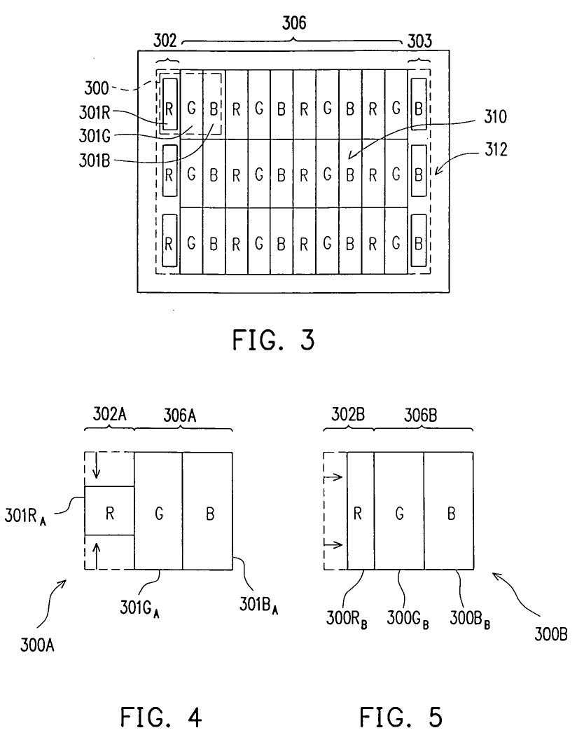

FIG. 3 is a schematic top view showing a display panel according to an embodiment of the present invention. As shown in FIG. 3, the display panel includes a display area 310 and a non-display area 312, wherein a plurality of pixels are disposed in the display area 310. Each pixel, such as pixel 300, includes three sub-pixels, such as sub-pixels 301R, 301G and 301B, with respect to three primary colors R, G and B, for example. These sub-pixels are arranged in a two-dimensional array of columns and rows. The number of columns and the number of rows depicted in FIG. 3 are merely exemplary. The sub-pixels are liquid crystal display sub-pixels in this embodiment. In other embodiments, however, various other types of pixels can be used, such as electroluminescent display sub-pixels (such as organic or inorganic light emitting diode sub-pixels) or plasma display sub-pixels, for example. In addition, several driving integrated circuits (ICs) (not shown) are located in the non-display area 310 for driving the sub-pixels. In other embodiments, at least some of the driving ICs can be located in other areas.

In FIG. 3, the display area 310 includes peripheral regions 302 and 303 and a non-peripheral region 306. The R, G and B sub-pixels are arranged in a stripe-type configuration. That is, the sub-pixels arranged in the same column exhibit the same color. In this embodiment, the sub-pixel sequence is RGB, and thus the sub-pixels at the first column are red and the sub-pixels at the second column are green. However, in other embodiments, the sub-pixel sequence can be different. It should be noted that the arrangement of the peripheral regions 302 and 303 and the non-peripheral region 306 is not limited to the configuration shown in FIG. 3 in other embodiments. For instance, in some embodiments, the peripheral regions can be disposed around the non-peripheral region.

Notably, the sub-pixels disposed in the peripheral regions 302 and 303 have a brightness lower than that of the sub-pixels disposed in the non-peripheral region 306. In order to reduce the brightness of the sub-pixels 301 in the peripheral region 302 various techniques can be used, such as adjusting the sub-pixel size, forming an opaque or semiopaque material layer to at least partially obscure the sub-pixels, adjusting the sub-pixel thickness or material, and/or adjusting driving voltage.

In the embodiment of FIG. 3, the sub-pixels disposed in the peripheral regions 302 and 303 are smaller than the sub-pixels 301 in the non-peripheral region 306. Because the sub-pixels in the peripheral regions 302 and 303 are smaller than the sub-pixels of the non-peripheral region 306, the effective brightness at the peripheral region 302 is reduced.

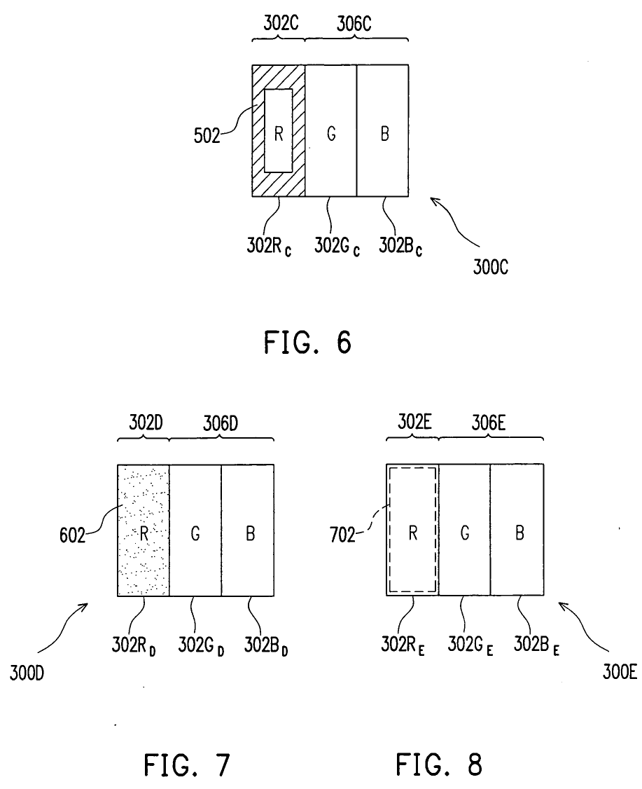

Alternatively, under the same design principle, the sub-pixels in the peripheral regions are reduced in size by only one-dimension or “one-direction reducing,” as shown in FIG. 4 and FIG. 5. In FIG. 4, a pixel 300A, including three sub-pixels 301R_{A}, 301G_{A} and 3O1B_{A} disposed near the edge of the display panel, is shown. The reducing direction is the column direction (as indicated by the arrows). In other words, the length of each of the sub-pixels in the peripheral region 302A is reduced. Similarly, as shown in FIG. 5, the reduction in size can be achieved in the row direction (as indicated by the arrows). In that embodiment, the width of each of the sub-pixels in the peripheral region 302B is reduced.

Basically, the reduction ratio can be, for example, about 30%-70%. In other words, the size of the sub-pixels in the peripheral regions can be reduced to about 30%-70% relative to the sub-pixels disposed in the non-peripheral region. Therefore, the brightness of the sub-pixels in the peripheral regions is reduced to about 30%-70% of the original brightness.

FIG. 6 schematically shows another example. The size of the sub-pixel 301R_{C} in the peripheral region 302C is identical to that of the sub-pixels in the non-peripheral region 306C. In the peripheral region 302C, a portion of the sub-pixel 301R_{C} is covered by an opaque material 502 leaving a central portion of the sub-pixel exposed. As a result, the central portion can produce the desired brightness. In other words, the brightness of the peripheral region 302C is reduced by the opaque material. Also, the pattern of the opaque material 502 is not limited to the frame configuration shown in FIG. 6.

FIG. 7 schematically shows another example. The sub-pixel 301R_{D} in the peripheral region 302D is covered by a semi-opaque material 602. As a result, the transmittance of the sub-pixel 301R_{D} in the peripheral region 302D is lower than that of the sub-pixels in the non-peripheral region 306D.

The material of an opaque or semi-opaque layer(s) of a sub-pixel in a peripheral region can be a dielectric layer, a conductive layer, an organic layer, an inorganic layer or a combination thereof.

FIG. 8 schematically shows another example. In this embodiment, a sub-pixel 301R_{E} in the peripheral region 302E incorporates a color filter 702 that exhibits a lower transmittance than a color filter of another sub-pixel located in non-peripheral region 306E. For reducing transmittance, a material of the color filter 702 can be different from the color filter of another sub-pixels, or a thickness of the color filter 702 can be thicker than the color filter of another sub-pixels. As a result, the brightness of the sub-pixels in the peripheral region 302E can be reduced. Alternatively, a thickness of the sub-pixels in peripheral region can be adjusted for reduced brightness thereof, such as by increasing the thickness of the sub-pixels.

FIG. 9 schematically shows another example. When the image is displayed, a set of driving voltages is respectively applied to the sub-pixels. In this embodiment, the sub-pixels in non-peripheral region 306F are connected to a first driving voltage V1 and the sub-pixels in the peripheral region 302F are connected to a second driving voltage V2, wherein the first driving voltage V1 is different from the second driving voltage V2. When driving voltage is increased, transmittance is reduced in normally white-type LCDs. Thus, the second driving voltage V2 applied on the sub-pixels in the peripheral region 302F is set higher than the first driving voltage V1 for the sub-pixels in the non-peripheral region 306F.

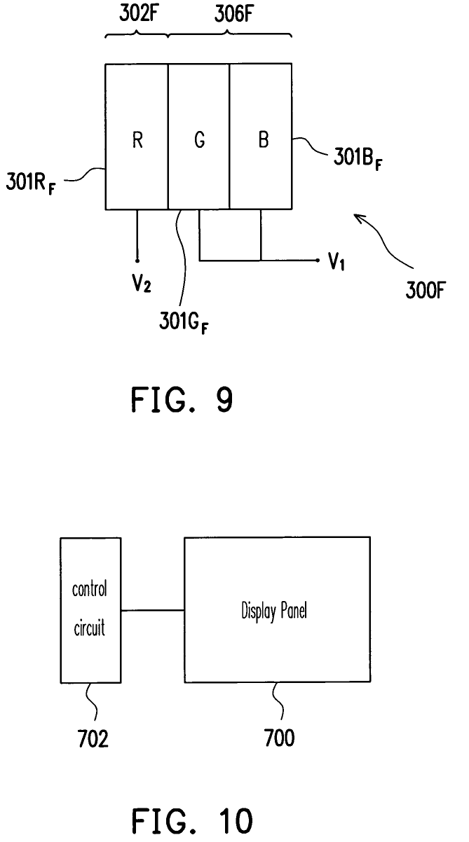

Embodiments of systems for reducing color lines can be implemented with a variety of devices that incorporate displays. In FIG. 10, an embodiment of such a system incorporates a display device that comprises a display panel 700 and a control circuit 702 electrically connected to the display panel. The circuit 702 controls imaging of the display panel 700. The display panel 700 can include pixel configurations such as mentioned above. Additionally, the display panel 700 can be for example, a liquid crystal display (LCD) panel, an electroluminescent (EL) display panel, such as an organic light emitting diode (OLED) display panel or inorganic light emitting diode display panel or a plasma display panel (PDP).

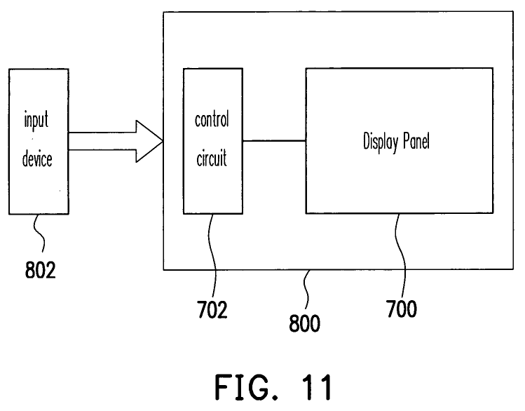

FIG. 11 is a diagram illustrating another embodiment of a system, in this case, an electronic device. In FIG. 11, the electronic device comprises a display device 800 and an input device 802 for providing input data to the display device 800. The electronic device can be, for example, a television set, a computer system, a mobile phone, or a gaming device.

It will be apparent to those skilled in the art that various modifications and variations can be made to the structures described herein without departing from the scope or spirit of the invention.

What is claimed is:

1. A system for reducing color lines at edges of a display, said system comprising:
a display comprising a peripheral region and a non-peripheral region, the non-peripheral region including at least a central image-displaying portion of the display, the peripheral region including at least one image-displaying edge portion of the display,
the peripheral region and the non-peripheral region comprising sub-pixels, wherein the sub-pixels disposed in the peripheral region have a brightness lower than that of the sub-pixels disposed in the non-peripheral region.

2. The system of claim 1, wherein the sub-pixels disposed in the peripheral region are smaller than the sub-pixels disposed in the non-peripheral region.

3. The system of claim 1, wherein the brightness of at least one of the sub-pixels in the peripheral region is 30%-70% of the brightness of at least one of the sub-pixels disposed in the non-peripheral region.

4. The system of claim 1, wherein at least a portion of the sub-pixels in the peripheral region are covered by an opaque material layer.

5. The system of claim 1, wherein at least a portion of the sub-pixels in the peripheral region are covered by a semi-opaque material layer.

6. The system of claim 1, wherein the sub-pixels disposed in the peripheral region have a thickness larger than that of the sub-pixels disposed in the non-peripheral region.

7. The system of claim 1, wherein the display is a liquid crystal display.

8. The system of claim 7, wherein the sub-pixels comprise a plurality of color filters, wherein the color filters in the peripheral region are different from the color filters in the non-peripheral region exhibiting the same color.

9. The system of claim 8, wherein the color filters in peripheral region exhibit lower transmittance than the color filters in the non-peripheral region.

10. The system of claim 1, wherein the material for the sub-pixels disposed in the peripheral region has a transmittance lower than that of the sub-pixels disposed in the non-peripheral region.

11. The system of claim 1, wherein the sub-pixels comprise sub-pixels of three primary colors R, G and B.

12. The system of claim 1, wherein each of the sub-pixels arranged in a column are the same color.

13. The system of claim 11, wherein the peripheral region comprises two opposing side edges of the display.

14. The system of claim 1, wherein the sub-pixels are electroluminescent display sub-pixels or plasma display sub-pixels.

15. The system of claim 1, wherein the sub-pixels in the non-peripheral region are electrically connected to a first driving voltage and the sub-pixels in the peripheral region are electrically connected to a second driving voltage different from the first driving voltage.

16. The system of claim 1, further comprising:
a control circuit electrically connected to the display and operative to control imaging of the display.

17. The system of claim 1, further comprising:
means for controlling imaging of the display.

18. The system of claim 16, further comprising:
an input device for providing input data to the display such that the display renders an image.

19. A system for reducing color lines at edges of a display comprising:
a display comprising pixels, the pixels having sub-pixels arranged in a striped configuration such that sub-pixels of a first color are located in an outermost column of the sub-pixels, wherein a brightness of the sub-pixels of the outermost column is lower than a brightness of other sub-pixels located closer to a center of a display portion of the display.

20. The system of claim 19, further comprising:
means for visually obstructing at least a portion of the sub-pixels of the outermost column.
